(19) United States
(12) Patent Application Publication
(10) Pub. No.: US 2009/0093553 A1
(43) Pub. Date: Apr. 9, 2009

(54) METHOD FOR THE PRODUCTION OF SUSPENSIONS OF NANOPARTICULATE SOLIDS

(76) Inventors: Frank Kleine Jager, Bad Durkheim (DE); Julian Prolss, Worms (DE); Alexander Benohr, Speyer (DE); Thomas Breiner, Heppenheim (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/299,336

(22) PCT Filed: May 8, 2007
(86) PCT No.: PCT/EP07/54457

§ 371 Date: Nov. 3, 2008

(30) Foreign Application Priority Data
May 9, 2006 (EP) 06113735.2

(51) Int. Cl. B01F 17/00

(52) U.S. Cl. 516/33; 977/779

(57) ABSTRACT

The invention relates to a process for preparing suspensions of nanoparticulate solids, wherein the solids present in the suspension are present in the form of nanoparticulate primary particles or very small aggregates.

The invention relates to a process for preparing suspensions of nanoparticulate solids.

Nanoparticles refer to particles in the order of magnitude of nanometers. Their size is within the transition region between atomic or monomolecular systems and continuous macroscopic structures. As well as their usually very large surface area, nanoparticles are notable for particular physical and chemical properties, which differ significantly from those of larger particles. For instance, nanoparticles have a lower melting point, absorb light at shorter wavelengths and have different mechanical, electrical and magnetic properties than macroscopic particles of the same material. Use of nanoparticles as structural units allows many of these particular properties also to be utilized for macroscopic materials (Winnacker/Küchler, Chemische Technik: Prozesse und Produkte [Chemical Technology: Processes and Products] (eds.: R. Dittmayer, W. Keim G. Kreysa, A. Oberholz), Vol. 2: Neue Technologien [New Technologies], ch. 9, Wiley-VCH Verlag 2004).

Nanoparticles can be prepared in the gas phase. The literature discloses numerous processes for gas phase synthesis of nanoparticles, including processes in flame reactors, plasma reactors and hot wall reactors, inert gas condensation processes, free jet systems and supercritical expansion (Winnacker/Küchler, see above). A disadvantage of these processes is that the particles obtained can still aggregate in the gas phase owing to their high mobility, and the resulting aggregates, owing to the strong van der Waals interactions and the resulting high binding forces between the particles are redispersible only very poorly in fluids. The smaller the particles are, the greater is the problem. As well as the van der Waals interactions, sintering or covalent bonds can also adversely affect the redispersibility.

In order to obtain nanoparticles with very homogeneous properties, it is, as is common knowledge to those skilled in the art, advantageous to stabilize the gas phase conversion in terms of space and time. This makes it possible to ensure that all feedstocks are exposed to virtually the same conditions during the reaction and hence react to give homogeneous product particles.

US 20040050207 describes the preparation of nanoparticles by means of a burner, wherein the reactants are conducted to the reaction zone in a multitude of tubes and not mixed and reacted until they are there. In a similar manner, US 20020047110 explains the preparation of aluminum nitride powder, and JP 61-031325 the synthesis of optical glass powder.

DE 10243307 describes the synthesis of soot nanoparticles. The gas phase reaction is carried out between a porous body, which serves as a blowback safeguard, and an accumulation plate arranged above it. The reactant gases are passed through the porous body into the reaction chamber and converted there.

A burner and a process for preparing carbon nanoparticles in the gas phase are described in US 20030044342. In this case, the reactant gases are converted outside a porous body.

EP 1004545 proposes a process for pyrogenic preparation of metal oxides, wherein the reactants are passed through a shaped body with continuous channels and converted in a reaction chamber.

It was an object of the present invention to provide a process for preparing suspensions of nanoparticulate solids, wherein the solids present in the suspension are present in the form of nanoparticulate primary particles or very small aggregates. These suspensions should allow simplified further processing of nanoparticulate solids. It was a further object of the invention to provide a process for preparing suspensions of nanoparticulate solids of thermally unstable products which are obtainable only with difficulty by other routes.

This object is achieved by a process in which the nanoparticulate solids obtained in a gas phase reaction are converted directly to a liquid phase.

The present invention therefore provides a process for preparing suspensions of nanoparticulate solids, which comprises
a) conducting at least one feedstock and possibly further components through at least one reaction zone while subjecting them to a thermal reaction in which nanoparticulate primary particles are formed,
b) subjecting the reaction product obtained in step a) to a rapid cooling and
c) introducing the cooled reaction product obtained in step b) into a liquid to form a suspension in which the solids present are present in the form of nanoparticulate primary particles or very small aggregates.

The thermal reaction performed by the process according to the invention may in principle be any chemical reaction which is thermally induced and leads to the formation of nanoparticulate solids. Preferred embodiments are oxidation, reduction, pyrolysis and hydrolysis reactions. Moreover, the reaction may either be an allothermal process, in which the energy required for the reaction is supplied externally, or an autothermal process, in which the energy required results from a partial conversion of a feedstock. For the initiation of a reaction in a fixed location, burners are useful, as are plasma sources.

Typical products which can be obtained as nanoparticulate solids by the process according to the invention are carbon black, oxides of at least one of the elements Si, Al, Ti, In, Zn, Ce, Fe, Nb, Zr, Sn, Cr, Mn, Co, Ni, Cu, Ag, Au, Pt, Pd, Rh, Ru, Bi, Ba, B, Y, V, La, also hydrides of at least one of the elements Li, Na, K, Rb, Cs, B, Al, and also sulfides such as MoS₂, carbides, nitrides, chlorides, oxychlorides and elemental metals or semimetals such as Li, Na, B, Ga, Si, Ge, P, As, Sb, La and mixtures thereof.

The process according to the invention enables the preparation of suspensions of nanoparticulate solids proceeding from a multitude of different feedstocks and possibly further components. Suitable process configurations for obtaining at least one of the aforementioned products are described in detail hereinafter.

The course of the gas phase reaction can be controlled, as well as further parameters, by means of the following parameters:
composition of the reaction gas (type and amount of the feedstocks, additional components, inert constituents) and
reaction conditions in the course of reaction (reaction temperature, residence time, supply of the feedstocks into the reaction zone, presence of catalysts).

The process according to the invention for preparing suspensions of nanoparticulate solids can be subdivided into the following steps, which are described in detail hereinafter.

### Step a)

According to the invention, a reaction zone is supplied with at least one feedstock and possibly one or more further components which are subjected to a thermal reaction in which nanoparticulate primary particles are formed.

Useful feedstocks include any substances which can preferably be converted to the gas phase, such that they are present in gaseous form under the reaction conditions, and which can form a nanoparticulate solid by a thermal reaction. According to the product desired, the feedstocks for the process according to the invention may, for example, be element-hydrogen compounds, for instance hydrocarbons, boron hydrides or phosphorus hydrides, and also metal oxides, metal hydrides, metal carbonyls, metal alkyls, metal halides such as fluorides, chlorides, bromides or iodides, metal sulfates, metal nitrates, metal-olefin complexes, metal alkoxides, metal formates, metal acetates, metal oxalates, metal borates or metal acetylacetonates, and also elemental metals such as lithium, sodium, potassium, boron, lanthanum, tin, cerium, titanium, silicon, molybdenum, tungsten, platinum, rhodium, ruthenium, zinc or aluminum. Preferred feedstocks are element-hydrogen compounds and the elemental metals boron, zinc, lanthanum, tin, cerium, titanium, silicon, molybdenum, tungsten, platinum, rhodium, ruthenium and aluminum.

In addition to the at least one feedstock, the reaction zone can be supplied with an oxidizing agent as a further component, for example molecular oxygen, oxygenous gas mixtures, oxygen-comprising compounds and mixtures thereof. In a preferred embodiment, the oxygen source used is molecular oxygen. This enables the content of inert compounds in the reaction zone to be minimized. However, it is also possible to use air or air/oxygen mixtures as the oxygen source. The oxygen-comprising compounds used are, for example, water, preferably in the form of steam, and/or carbon dioxide. When carbon dioxide is used, it may be recycled carbon dioxide from the gaseous reaction product obtained in the reaction.

In a further embodiment of the invention, the reaction zone can be supplied with a reducing agent as a further component, for example molecular hydrogen, ammonia, hydrazine, methane, hydrogenous gas mixtures, hydrogen-comprising compounds and mixtures thereof. Particular preference is given to the conversion of aluminum in a hydrogen-argon plasma to form aluminum hydride (AlH₃) and the reaction of lanthanum oxide with boron or boron compounds to form lanthanum hexaboride (LaB₆).

If required, the reaction zone can be supplied with a combustion gas as a further component, which provides the energy required for the reaction. This may, for example, be H₂/O₂ gas mixtures, H₂/air mixtures, mixtures of methane, ethane, propane, butanes, ethylene or acetylene with air or other oxygenous gas mixtures.

Apart from the constituents mentioned so far, which can be used either individually or together, it is also possible to supply at least one further component to the reaction zone. These include, for example, any gaseous reaction products recycled, crude synthesis gas, carbon monoxide (CO), carbon dioxide (CO₂) and further gases for influencing the yield and/or selectivity of particular products or particle sizes, such as hydrogen or inert gases such as nitrogen or noble gases. In addition, it is also possible to supply finely divided solids or liquids as aerosols. These may, for example, be solids or liquids which are used for modification, aftertreatment or coating in the process, or which are themselves feedstocks.

In a preferred embodiment of the invention, two different metals are supplied simultaneously to the reaction zone. This can be done either in the form of a premixture of the two metals or by separate supply of the two individual metals. Particular preference is given to the conversion of the metals lithium and aluminum in the presence of hydrogen in a plasma to form lithium aluminum hydride.

The supply of solid feedstocks into the reaction zone can be accomplished, for example, with the aid of apparatus known to those skilled in the art, for example by means of brush feeders or screw feeders, and subsequent entrained flow delivery. The solid feedstocks are preferably used in pulverized form and form aerosols with a carrier gas, in which the particle sizes of the solid feedstocks may be within the same range as those of the nanoparticulate solids obtainable by the process according to the invention. The mean particle or aggregate size of the solid feedstocks is typically between 0.01 and 500 μm, preferably between 0.1 and 50 μm, more preferably between 0.1 and 5 μm. In the case of greater mean particle or aggregate sizes, there is the risk of incomplete conversion to the gas phase in the reaction zone, such that relatively large particles of this kind are available for the reaction only incompletely, if at all. In some cases, a surface reaction on incompletely evaporated particles can lead to the passivation thereof.

Liquid feedstocks can be supplied to the reaction zone, for example, in gaseous form or else in the form of vapor comprising liquid droplets, likewise with the aid of apparatus known to those skilled in the art. Suitable apparatus for this purpose includes evaporators, such as thin-film evaporators or flash evaporators, a combination of atomization and entrained flow evaporators, or evaporation in the presence of an exothermic reaction (low-temperature flame). There is generally no risk of incomplete reaction of the atomized liquid feedstock, provided that the liquid droplets have the dimensions less than 50 μm typical for aerosols.

In a preferred embodiment of the invention, the feedstocks and any further components present, actually before they are introduced into the reaction zone, are converted into the gas phase and mixed with one another. This is a possibility especially in the case of low-boiling feedstocks and any further components present, since they may already be present in gaseous form at temperatures at which there is still no chemical conversion. Alternatively, the different feedstocks and any further components present may also be converted to the gas phase separately and be supplied to the reaction zone in mutually separate gas streams, in which case their mixing is advantageously undertaken immediately before entry into the reaction zone.

When solid feedstocks and possibly further components are used and are each transported separately into the reaction zone by a carrier gas, the loading of the carrier gas is typically in each case between 0.01 and 2.0 g/l, preferably between 0.05 and 0.5 g/l. In the case that solid feedstocks and possibly further components are used and are transported into the reaction zone already as a mixture by a carrier gas, the loading of the carrier gas with the total amount of the solid feedstocks is typically between 0.01 and 2.0 g/l, preferably between 0.05 and 0.5 g/l. In the case of liquid and gaseous feedstocks, generally higher loadings than those mentioned are possible. The loadings suitable for the particular process conditions can usually be determined easily by appropriate preliminary tests.

The carrier gas used to transport solid or liquid feedstocks and possibly further components into the reaction zone may be any of the aforementioned gases, provided that it does not hinder the thermal reaction. Preference is given to using noble gases as the carrier gas.

The feedstocks and any further components introduced into the reaction zone are, in accordance with the invention, subjected to a thermal reaction in which nanoparticulate primary particles are formed. This is generally done by heating to high temperatures, useful methods for which include especially a flame or a thermal plasma, microwave plasma, light arc plasma, induction plasma, convection and/or radiation heating, autothermal reaction or a combination of the aforementioned methods.

Appropriate procedures and process conditions for bringing about heating of the components in the reaction zone by means of a flame or a thermal plasma, microwave plasma, light arc plasma, induction plasma, convection and/or radiation heating, autothermal reaction or a combination of the aforementioned methods are sufficiently well known to those skilled in the art.

In the case of autothermal reaction, a flame is generated, for example, by using mixtures of hydrogen and halogen gas, especially chlorine gas. In addition, the flame can also be obtained with hydrocarbons, for example methane, ethane, propane, butanes, ethylene or acetylene or else mixtures of the aforementioned gases on the one hand, and an oxidizing agent such as oxygen or an oxygenous gas mixture on the other hand, the latter also being usable in deficiency when reducing conditions are preferred in the reaction zone of a flame.

To obtain a plasma, a so-called plasma spray gun is frequently used. It consists, for example, of a casing which serves as the anode and of a water-cooled copper cathode arranged centrally therein, an electrical light arc of high energy density burning between the cathode and the casing. The plasma gas supplied, for example argon or a hydrogen/argon mixture, ionizes to form the plasma and leaves the cannon with a high velocity (from about 300 to 700 m/s) at temperatures of from 15 000 to 20 000 kelvin. The feedstocks are introduced directly into this plasma beam, evaporated there, and then converted to the desired product at suitable temperatures in a reactive atmosphere and after preceding cooling.

The gas or gas mixture used to obtain plasmas is typically a noble gas, such as helium or argon, or noble gas mixture, for example of helium and argon, or else hydrogen.

Noble gases, such as helium or argon, or noble gas mixtures, for example of helium and argon, may also find use as inert components in the reaction zone. In the specific case, it is also possible for nitrogen to be used, if appropriate in a mixture with the noble gases listed above, as an inert component in the reaction zone, but the formation of nitrides possibly has to be expected here at higher temperatures and depending on the nature of the feedstocks.

Typical powers introduced into a plasma are in the range from a few kW to several 100 s of kW. It is also possible in principle to use sources for plasma of relatively high power for the synthesis. Otherwise, the procedure for generating a stationary plasma flame is familiar to those skilled in the art, especially with regard to power introduced, gas pressure, gas rates for the plasma gas and protective gas. In addition, an inert protective gas is generally used, which places a gas layer between the wall of the reactor used for the generation of the plasma and the reaction zone, the latter corresponding essentially to the region in which the plasma is present in the reactor.

In the course of the reaction, according to the invention, on completion of nucleation, initially nanoparticulate primary particles form, which can be subject to further particle growth as a result of coagulation and coalescence procedures. Particle formation and growth proceed typically within the entire reaction zone and may also continue further after leaving the reaction zone until rapid cooling. When more than one solid product is formed during the reaction, the different primary particles formed may also combine with one another, which forms nanoparticulate product mixtures, for example in the form of cocrystals or amorphous mixtures. When a plurality of different solids are formed at different times during the reaction, it is also possible for enveloped products to form, in which the primary particles of a product formed first are surrounded by layers of one or more other products.

A further embodiment of the invention comprises a staged addition of feedstocks into the reaction zone. This allows, if appropriate, a homogeneous coating of a core with a shell to be achieved, if it is ensured, inter alia, that there is very rapid (i.e. within a few ms) homogeneous mixing of the particles formed in the first stage with the feedstock added in the second stage. By virtue of suitable process control, a homogeneous coating of the particles from the first stage with a layer having a thickness of a few nm of the product of the second stage is thus possible, even though this arrangement is thermodynamically disfavored (for example a silicon dioxide layer on a zinc oxide particle).

The control of these particle formation processes, apart from by the composition of the feedstocks and any further components and the reaction conditions, can also be controlled by the type and juncture of the cooling of the reaction product described in step b).

In any case, the temperature within the reaction zone must be above the boiling point of the feedstocks used and of any further components present. The reaction in the reaction zone for the autothermal reaction preferably proceeds at a temperature in the range from 600 to 1800° C., preferably from 800 to 1500° C., and, for plasma processes, at a temperature in the range from 600 to 10 000° C., preferably from 800 to 6000° C.

In general, the residence time of the feedstocks and of any further components in the reaction zone is between 0.002 s and 2 s, preferably between 0.005 s and 0.2 s.

In the process according to the invention, the thermal reaction of the feedstocks and any further components to prepare the inventive suspensions of nanoparticulate solids can proceed at any pressure, preferably in the range from 0.05 bar to 5 bar, especially at atmospheric pressure.

### Step b)

According to the invention, the conversion of the feedstocks and any further components in step a) is followed by a rapid cooling of the resulting reaction product in step b). In the context of this invention, rapid cooling is understood to mean a lowering of the temperature with a cooling rate of at least 10⁴ K's, preferably at least 10⁵ K/s, more preferably at least 10⁶ K/s.

This rapid cooling can proceed, for example, through direct cooling, indirect cooling, expansion cooling or a combination of direct and indirect cooling. In the case of direct cooling (quenching), a coolant is contacted directly with the hot reaction product, in order to cool it. Direct cooling can be carried out, for example, by means of the supply of quench oil, water, steam, liquid nitrogen or cold gases, if appropriate also cold recycled gases, as a coolant. For the supply of the coolant, for example, an annular gap burner can be used, which enables very high and uniform quench rates and is familiar per se to those skilled in the art.

In the case of indirect cooling, thermal energy is withdrawn from the reaction product, without it coming into direct contact with a coolant. An advantage of indirect cooling is that it generally enables effective utilization of the thermal energy transferred to the coolant. To this end, the reaction product can be contacted with the exchange surfaces of a suitable heat exchanger. The heated coolant can be used, for example, to heat the feedstocks in the process according to the invention or in a different endothermic process. In addition, the heat withdrawn from the reaction product can, for example, also be used to operate a steam generator.

Preference is given to performing the process according to the invention in such a way that, in step b), the resulting reaction product is cooled to a temperature in the range from 1800° C. to 20° C. According to the process and product, cooling to a temperature of less than 650° C. or even less than 250° C. may be necessary in order to prevent further growth of particles and the aggregation or sintering thereof.

In a preferred embodiment of the invention, the cooling is effected in two stages, in which case combined use of direct cooling (preliminary quench) and indirect cooling is also possible. In this case, direct cooling (preliminary quench) can cool the reaction product obtained in step a) preferably to a temperature of less than 1000° C. Two-stage cooling is a possibility especially for thermally labile products, in order to prevent their decomposition. In this case, the product should be cooled in the first stage with very rapid cooling (i.e. with a very high cooling rate of at least 10⁵ K/s, preferably at least 10⁶ K/s) to a temperature below the decomposition temperature. In the first stage, preference is given to cooling rapidly to a temperature which is below one third of the particular melting or decomposition temperature of the product in kelvin, in order as far as possible to suppress decomposition or sintering processes. Subsequently, cooling can be continued with a lower cooling rate. The first stage may comprise, for example, direct cooling by addition of liquid nitrogen or white oil to the gas stream, the second stage indirect cooling by means of a heat exchanger.

The size of the solid particles in the suspensions of nanoparticulate solids prepared by the process according to the invention is typically in the range from 1 to 500 nm, preferably from 2 to 100 nm.

In a further embodiment of the process according to the invention, during or immediately after the quenching, the particles formed can be processed further in the gas phase, for example by coating with an organic coating and/or by modification of the surface with organic compounds. Preference is given in this case to adding quench gas and modifier simultaneously. Organic compounds suitable as modifiers are known in principle to those skilled in the art. Preference is given to using those compounds which can be converted to the gas phase without decomposition and which can form a covalent or adhesive bond to the surface of the particles formed. For the organic coating or the organic modification, it is possible, for example for metal oxide particles, to use different organosilanes such as dimethyldimethoxysilane, methyltrimethoxysilane, methyltriethoxysilane, methylcyclohexyldimethoxysilane, isooctyltrimethoxysilane, propyltrimethoxysilane, isobutyltrimethoxysilane, phenyltrimethoxysilane or octyltriethoxysilane. When the particles consist of SiO₂ or are present with SiO₂-coated particles, the SiOH groups on the surface of the particles can possibly enter directly into a covalent or adhesive bond with the silane. The silanes present on the surface of the particles are expected to lower the interactions between the particles as spacers, to facilitate the mass transfer into an organic matrix in the wet precipitator, and to be able to function as coupling sites in any subsequent further functionalization (if appropriate after concentration).

Preference is given to performing the process of modification in such a way that the supply of the quench gas or controlled removal of heat after supply of the quench gas allows controlled condensation of the modifier onto the particles. Furthermore, in a downstream step, further aqueous or organic modifiers can be added to promote the condensation. Particular preference is given to the use of a modifier which is also present in the liquid used in step c).

### Step c)

In the process according to the invention, the cooled reaction product obtained in step b) is introduced into a liquid to form a suspension in which the solids present are present in the form of nanoparticulate primary particles or very small aggregates thereof. As a result, the nanoparticulate primary particles which are still present in isolated form or very small aggregates are protected from further agglomeration by being introduced directly into a liquid phase.

The liquid may, in accordance with the invention, comprise aqueous or nonaqueous, organic or inorganic liquids or mixtures of at least two of these liquids. In addition, it is also possible to use ionic liquids. Preferred liquids are white oil, tetrahydrofuran, diglyme, Solvent Naphtha, water or 1,4-butanediol. Further constituents may be dissolved in the liquids, for example salts, surfactants or polymers, which can serve, inter alia, as modifiers and can increase the stability of the suspensions. Preference is given to using aqueous or organic liquids, particularly water.

To perform the inventive process step c), it is possible to use customary apparatus known to those skilled in the art, for example wet electrostatic precipitators or Venturi scrubbers. If appropriate, the nanoparticulate solids formed may be fractionated during the precipitation, for example by fractional precipitation. The precipitation can possibly be intensified by promoting the condensation, and the suspension formed can be stabilized further by modifiers. Suitable substances for surface modification are anionic, cationic, amphoteric or nonionic surfactants, for example Lutensol® or Sokalan® brands from BASF Aktiengesellschaft.

In a preferred embodiment of the invention, in the upstream part of a wet electrostatic precipitators, a surfactant-containing liquid is metered in continuously. Owing to the generally vertical arrangement of the wet electrostatic precipitator, a continuous liquid film is formed on the wall within its tubular precipitating vessel. The continuously circulated liquid is collected in the downstream part of the wet electrostatic precipitator and delivered by means of a pump. Preferably in countercurrent to the liquid, the gas stream laden with the nanoparticulate solid flows through the wet electrostatic precipitator. In the tubular precipitating vessel, there is a central wire which functions as the spray electrode. Between the vessel wall which serves as the counter electrode and the spray electrode, a voltage of from about 50 to 70 kV is applied. The gas stream laden with the nanoparticulate solid flows from above into the precipitating vessel, gas-borne particles being charged electrically by the spray electrode and the precipitation of the particles on the counter electrode (i.e. the wall of the wet electrostatic precipitator) thus being induced. Owing to the liquid film flowing along the wall, the particles are precipitated directly in the film. The charging of the particles simultaneously brings about prevention of undesired particle agglomeration. The surfactant leads to the formation of a stable suspension. The degree of precipitation is generally above 95%.

In a further preferred embodiment of the invention, a Venturi scrubber is used for precipitation. Owing to the high turbulence in the region of the Venturi throat, there is very efficient precipitation even of nanoparticulate solids. Addition of surfactants to the circulated precipitation medium (for example water, white oil, THF) allows the agglomeration of precipitated particles to be prevented. Preference is given to establishing a pressure difference over the throat of the Venturi scrubber in the range from 20 to 1000 mbar, more preferably from 150 to 300 mbar. This process allows nanoparticles with particle diameters of less than 50 nm to be precipitated with a degree of precipitation of greater than 90%.

For workup, the reaction product obtained in step b), before being introduced into a liquid, may be subjected to at least one separation and/or purification step. The nanoparticulate solids formed are separated from the remaining constituents of the reaction product.

The process according to the invention is thus suitable for continuous or batchwise preparation of suspensions of nanoparticulate solids. Important features of this process are rapid energy supply at a high temperature level, generally short and uniform residence times under the reaction conditions, and rapid cooling (“quenching”) of the reaction products with subsequent conversion of the particles to a liquid phase, which prevents agglomeration of the nanoparticulate primary particles formed or too extensive a conversion. The products obtainable by the process according to the invention can be processed further easily and allow the simple achievement of novel material properties which are attributable to nanoparticulate solids.

The invention is illustrated in detail by the examples which follow.

### EXAMPLES 1 to 3

### Preparation of Suspension of Nanoparticulate Zinc Oxide

Elemental zinc was passed into a tube furnace with a brush feeder with a mass flow of from 10 to 40 g/h together with a nitrogen carrier gas stream (1 m³ (STP)/h) and evaporated there at approx. 1000° C., then introduced in gaseous form into the reaction zone of a burner and reacted there with atmospheric oxygen (4 m³ (STP)/h) at temperatures in the range from 950 to 1200° C. to give zinc oxide. To maintain and to moderate the reaction temperature, hydrogen (1 m³ (STP)/h) and air (6 m³(STP)/h) were additionally metered into the reaction zone. After a residence time in the reaction zone of from 20 ms to 50 ms, the reaction product is cooled to about 150° C. by means of an annular gap with air as the quench medium (100 to 150 m³ (STP)/h), the cooling rate being at least 10⁵ K/s. For surface modification, evaporated hexamethyldisiloxane was added.

Subsequently, the gas-borne zinc oxide particles were precipitated by means of a wet electrostatic precipitator in which 1,3-butanediol with 2% by weight of hexamethyldisiloxane (HMDS, ex. 1) or 2% by weight of Lutensol® AO5 (ex. 2) or Solvent Naphtha with 2% by weight of HMDS (ex. 3) as the precipitation medium has been circulated by means of a pump. Electrical charges were applied to the zinc oxide particles entering the wet electrostatic precipitator by means of a spray electrode which is arranged centrally in the wet electrostatic precipitator. The voltage applied was 60 kV. to 3 show the particle size distributions of the resulting suspensions.

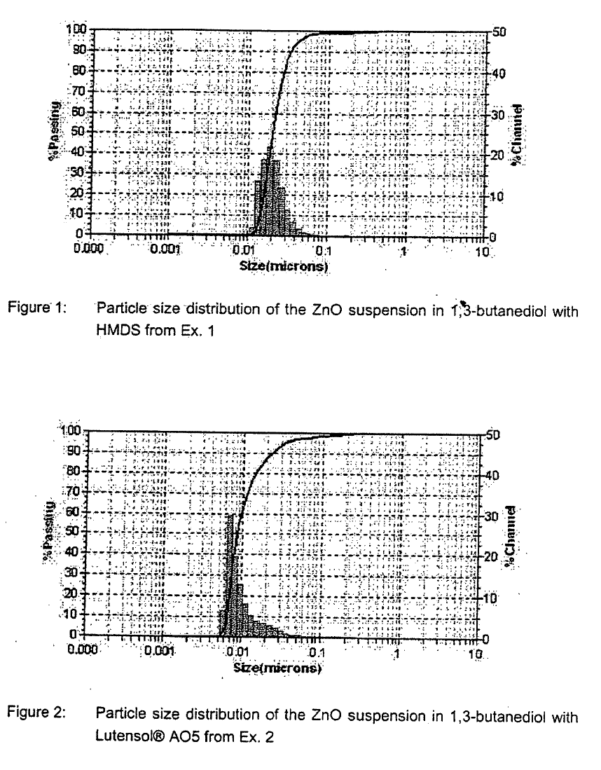

These results show that FIG. 1 the samples prepared are of low dispersion hardness and the particle size distribution depends greatly on the formulation.

### EXAMPLE 4

### Preparation of a Suspension of Nanoparticulate Aluminum Hydride in White Oil

A plasma system (from Sulzer Metco) was used to provide a light arc plasma with an electrical power of 45 kW, and temperatures of T˜10 000 K were achieved owing to the thermal power introduced. The plasma gases used were argon with a volume flow \dot{V}=50 l (STP)/min and hydrogen with \dot{V}=20 l (STP)/min. In addition, aluminum particles with a mean size of d₅₀=9 μm were conveyed as a feedstock into the reaction zone of the plasma with the aid of an argon carrier gas stream of \dot{V}=14 l (STP)/min. Upstream of the reactor entrance, hydrogen was metered in as a reaction gas at up to \dot{V}=35 m³ (STP)/h, in order to react as a reactant with aluminum to give aluminum hydride. After a few μs, quenching was effected in the reaction zone via an annular gap by addition of argon (up to \dot{V}=330 m³ (STP)/h). The temperature after the quench was approx. 350 K; the quench rate was 10⁶ K/s.

In a Venturi scrubber with a throat diameter of 14 mm, the particles were precipitated in white oil (\dot{V}=125 l/h), and were in turn precipitated in a cyclone and collected in a reservoir vessel. The offgas was passed through a spray scrubber. The process pressure in the scrubber was approx. 1.5 bar (abs). Downstream of the scrubber, the solids-free process gas, consisting essentially of argon and hydrogen, was recycled by using it repeatedly as the quench medium.

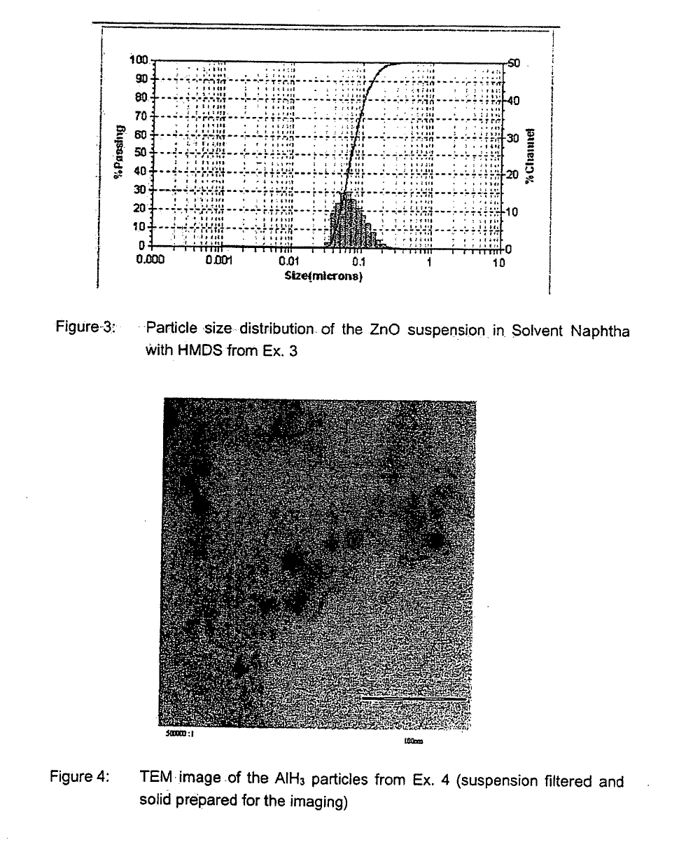

The particle size distribution of the resulting product exhibited a mean particle size of from approx. 30 to 50 nm. FIG. 4 shows a transmission electron microscopy (TEM) image of the solid isolated from the product.

### EXAMPLE 5

### Preparation of a Suspension of Nanoparticulate Lanthanum Hexaboride in White Oil

20 g/h of a high-dispersity mixture of 40% by weight of amorphous boron and 60% by weight of La₂O₃ (molar B:La ratio=10:1) were metered with an argon carrier gas stream (180 l/h) into the reaction zone of an induction plasma at a temperature of above 5000 K. In addition, a stream of 3.6 m³ (STP)/h of a gas mixture composed of 75% by volume of Ar, 10% by volume of hydrogen and 15% by volume of He was added to the induction plasma. The plasma was excited with a power of 30 kW. After a rapid quench, the particle-laden gas stream was passed into a Venturi scrubber in which white oil was circulated as a precipitation medium. The nanoparticulate product composed of LaBs formed, owing to the rapid quench and the immediate precipitation of the LaB₆ particles in white oil, comprised virtually no agglomerates. The resulting primary particles had a size of from 25 to 50 nm. The particle size distribution measured in the suspension by means of dynamic light scattering exhibited a Dso value of 50 nm and a D₅₀ value of 85 nm.

### EXAMPLE 6

### Preparation of a Suspension of Nanoparticulate Molybdenum Disulfide in White Oil

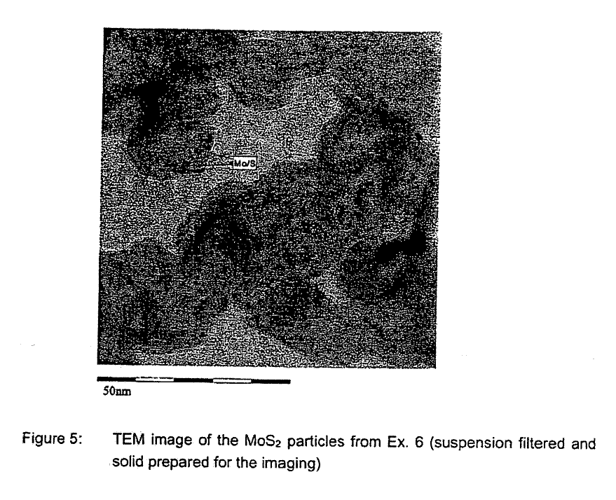

In a hot wall reactor with an electrical power of 30 kW, a temperature of 800° C. was provided. The purge gases used for the heated tube were nitrogen with V=0.5 m³ (STP)/h and hydrogen with V=0.1 m³ (STP)/h. The purge gases were preheated to 175° C. and passed into a reservoir comprising molybdenum chloride heated to 175° C. This volatilized molybdenum chloride until saturation of the purge gases was achieved. Just before entry into the hot wall reactor, the mixture was mixed with 30 l (STP)/h of hydrogen sulfide. In the reaction zone, molybdenum chloride reacted with hydrogen sulfide to give molybdenum disulfide. After a residence time of about 150 ms, nitrogen was passed into the hot gas as a quench with a volume flow of 10 m³ (STP)/h. The temperature downstream of the quench was approx. 350 K; the process pressure was 980 mbar absolute. In the downstream Venturi scrubber, the particles with particle sizes from 20 to 50 nm were precipitated in white oil (\dot{V}=250 l/h), which was in turn precipitated in a cyclone and collected in a receiver vessel. The offgas was sent to postcombustion. FIG. 5 shows a transmission electron microscopy (TEM) image of the solid isolated from the product.

1. A process for preparing suspensions of nanoparticulate solids, which comprises
a) conducting a feedstock or feedstocks and possibly a further component through a reaction zone while subjecting them to a thermal reaction in which nanoparticulate primary particles are formed,
b) subjecting the reaction product obtained in step a) to a rapid cooling and
c) introducing the cooled reaction product obtained in step b) into a liquid to form a suspension in which the nanoparticle solids are present in the form of nanoparticulate primary particles or very small aggregates.

2. The process according to claim 1, wherein the feedstock comprises an element-hydrogen compound or an elemental metal selected from the group consisting of boron, zinc, lanthanum, tin, cerium, titanium, silicon, molybdenum, tungsten, platinum, rhodium, ruthenium and aluminum.

3. The process according to claim 1, wherein the feedstock used is aluminum and the further component used is hydrogen, which are converted to aluminum hydride in the reaction zone.

4. The process according to claim 1, wherein the feedstocks used are lanthanum oxide and boron or boron compounds, which are converted to lanthanum hexaboride in the reaction zone.

5. The process according to claim 1, wherein the feedstocks used are lithium and aluminum and the further component used is hydrogen, which are converted to lithium aluminum hydride in the reaction zone.

6. The process according to claim 1, wherein the particle size of the nanoparticulate solids is in the range from 1 to 500 nm.

7. The process according claim 1, wherein the residence time of the feedstocks and of any further components in the reaction zone is between 0.002 s and 2 s.

8. The process according to claim 1, wherein the thermal conversion of the reaction gas proceeds at a pressure in the range from 0.05 bar to 5 bar.

9. The process according to claim 1, wherein the rapid cooling in step b) is effected with a cooling rate of at least 10⁴ K/s.

10. The process according to claim 1, wherein the rapid cooling in step b) is effected to a temperature which is below one third of the melting or decomposition temperature of the product in Kelvin.

11. The process according to claim 1, wherein the liquid used in step c) is white oil, tetrahydrofuran, diglyme, Solvent Naphtha, water or 1,4-butanediol.

12. The process according to claim 1, wherein a wet electrostatic precipitator or a Venturi scrubber is used in step c).

13. The process according to claim 1, wherein step b) comprises the addition of a modifier.

14. The process according to claim 13, wherein a quench gas and the modifier are added simultaneously.

15. The process according to claim 2, wherein the feedstock used is aluminum and the further component used is hydrogen, which are converted to aluminum hydride in the reaction zone.

16. The process according to claim 2, wherein the feedstocks used are lanthanum oxide and boron or boron compounds, which are converted to lanthanum hexaboride in the reaction zone.

17. The process according to claim 2, wherein the feedstocks used are lithium and aluminum and the further component used is hydrogen, which are converted to lithium aluminum hydride in the reaction zone.

18. The process according to claim 2, wherein the particle size of the nanoparticulate solids is in the range from 1 to 500 nm.

19. The process according to claim 3, wherein the particle size of the nanoparticulate solids is in the range from 1 to 500 nm.

20. The process according to claim 4, wherein the particle size of the nanoparticulate solids is in the range from 1 to 500 nm.
